(19) United States
(12) Patent Application Publication
(10) Pub. No.: US 2010/0086004 A1
(43) Pub. Date: Apr. 8, 2010

(54) Heating Chamber and Screening Methods

(75) Inventors: David V. Dellar, Midland, MI (US); Matthew T. Bishop, Midland, MI (US); Andrew J. Pasztor, JR., Midland, MI (US); Paul L. Morabito, Midland, MI (US); Steven P. Witer, Beaverton, MI (US)

Correspondence Address: THE DOW CHEMICAL COMPANY;MCDONNELL BOEHNEN HULBERT & BERGHOFF, LLP, 300 S. WACKER DRIVE, SUITE 3100, SEVENTH FLOOR, CHICAGO, IL, 60606, US

(73) Assignee: DOW GLOBAL TECHNOLOGIES INC., Midland, MI (US)

(21) Appl. No.: 12/573,432

(22) Filed: Oct. 5, 2009

Related U.S. Application Data
(60) Provisional application No. 61/103,449, filed on Oct. 7, 2008.

(51) Int. Cl. G01N 25/00; F27D 11/00

(52) U.S. Cl. 374/14; 219/438

(57) ABSTRACT

The invention provides, in one aspect, a parallel heat treatment device, including an inner heating chamber defined at least in part by a plurality of heating plate assemblies, each of the plurality of heating plate assemblies including a pair of separate and spaced heating plates. At least one heating element is disposed between each of the pair of heating plates. A test plate is disposed within the inner heating chamber, the test plate being sized and shaped to receive a plurality of sample pans and samples and a temperature controlled support plate is positioned underneath the test plate.

### BACKGROUND OF THE INVENTION

1. Field of the Invention

The invention is directed to high throughput devices and methods for thermogravimetric analysis of materials.

2. Description of Related Art

Thermogravimetric analysis is useful for evaluating various properties of materials samples, notably for the evaluation of thermal degradation properties. According to known thermogravimetric analysis techniques, the temperature of a sample is closely monitored as the sample is heated. A purge gas, such as nitrogen or air, can be supplied to control the composition of the chamber gases. The sample is weighed before, after, and in some instances during the heating, and chemical properties of the sample are inferred from changes in the weight of the sample.

Known systems for thermogravimetric analysis typically permit the analysis of only one sample at a time. These systems employ small heating chambers, which make it easier to provide precise control of the sample temperature and to avoid any significant temperature gradient across the sample. However, depending on the analysis being conducted, the entire test cycle time of a single sample can be substantial, typically 30 minutes or longer. When a large number of samples must be analyzed, the total testing time required can be quite long, taking many hours if not days, if using known systems for which the analysis is one sample at a time. Therefore, equipment and methods for thermogravimetric analysis, which could reduce the amount of analysis time per sample and improve productivity, would be a great benefit in situations that require rapid thermogravimetric analysis of large numbers of samples.

There is a demand for high throughput devices and methods for thermogravimetric analysis. The invention satisfies the demand. Other limitations of the prior art device and method are also satisfied by the invention, as will be detailed herein.

### SUMMARY OF THE INVENTION

The equipment systems and associated methods described herein provide the ability to conduct simplified types of thermogravimetric analysis with benefits of significantly reduced testing time per sample and generally improved productivity as compared to thermogravimetric analysis with known systems. The equipment systems disclosed herein, referred to as pTGA systems (for parallel thermogravimetric analysis), comprise a device for heating multiple samples simultaneously, i.e., at the same time and under the same conditions, and a device for robotic weighing of samples at various stages in the overall analysis. The device for parallel heat treatment of samples makes use of a test plate for holding a plurality of sample pans and a heating chamber designed to promote even heating across all samples, and has provision for controlled composition and flow of gases through the chamber. As described in further detail below, the heating chamber incorporates one or more of several design features to promote even heating.

It is an aspect of the invention that the chamber of the heat treatment device provides heating of all the samples held on the test plate. Suitable methods of heating the chamber and the test plate and samples within the chamber include conductive, radiant, and convective heating. Generally, a combination of these will be more suitable than any one heating method alone.

One aspect of the invention provides a parallel heat treatment device, including an inner heating chamber including a plurality of inner heating chamber walls. A plurality of heating plate assemblies are provided, each of which are disposed outside of and spaced-apart from a respective one of the plurality of inner heating chamber walls. A bottom heating plate assembly is positioned within a bottom portion of the inner heating chamber. At least one heating element is disposed in heating operative communication with each of the plurality of heating plate assemblies and the bottom heating plate assembly. A test plate is provided that is positionable within the inner heating chamber on the bottom heating plate assembly, the test plate being sized and shaped to receive a plurality of sample pans and a temperature-controlled support plate is positioned underneath the bottom heating plate assembly.

These, and additional objects, advantages, features and benefits of the invention will become apparent from the following specification.

### BRIEF DESCRIPTION OF THE DRAWINGS

These drawings illustrate one possible embodiment of a device for parallel heat treatment of samples constituting part of an equipment system for parallel thermogravimetric analysis. This heat treatment device is of the radiant plus convective heating type as described in the overview of the invention.

FIG. 1 is an exploded perspective view of a heating chamber for parallel heat treatment.

FIG. 2 is an exploded front view of a heating chamber for parallel heat treatment.

FIG. 3 is a cutaway perspective view of a heating chamber for parallel heat treatment, including a cutaway view of a test plate positioned in the heating chamber.

FIG. 4 is an exploded perspective view of a heating chamber for parallel heat treatment, including a test plate.

FIGS. 5a-c illustrate the labyrinth plate designed for distributing gas flow uniformly through the heating chamber. FIG. 5a is a top view (relative to the position of the labyrinth plate as installed in the heating chamber, FIG. 5b is a front view, and FIG. 5c is a perspective view.

FIG. 6 is a top view of a test plate.

### DETAILED DESCRIPTION OF THE INVENTION

A parallel heat treatment device where a majority of the heating of the test plate and samples occurs via conductive heating is set out in one embodiment of the invention. Such a device relies on conductive heating being a major mode of heat transfer from elements of the heat treatment device that are in direct contact with the test plate into the test plate. This heat in turn is conducted into the sample pans (which rest in depressions, or the like, in the test plate) and thus into the samples. At some point in the method, the test plate is put into contact with a support plate that resides in the heating chamber. More rapid and uniform conduction of heat from the support plate into the test plate, and thus sample pans and samples, is promoted if the support plate is uniformly at the desired temperature, is of much larger mass than the assembly of test plate plus samples, has high thermal conductivity, or has edges spaced-apart from the edges of the test plate, or combinations thereof. If the apparatus design incorporates these features, then removing the support plate from the chamber and placing the test plate on the support plate results in an insignificant drop in temperature of the support plate because the support plate has much greater thermal mass than the test plate plus samples, and the boundary conditions for heat conduction are such that heat flows uniformly and rapidly up into the test plate. Thus, in one embodiment, the heat treatment chamber includes a temperature-controlled support plate, which has much greater mass than the test plate and which is heated or cooled to the desired test temperature, with a means of rapidly introducing the test plate onto the support plate and a means of rapidly removing the test plate from the support plate at the end of heat treatment. The support plate may be heated or cooled electrically or by recirculating fluid or by placement in a larger oven or environmental chamber. When the support plate is heated electrically or by recirculating fluid, control of the composition and flow of gases over the test plate can be achieved by means of a small enclosure over the test plate with inlet and outlet for gas flow that encloses the test plate. When the support plate resides in a larger oven or environmental chamber, it is usually heated by convection to the same temperature as the gases in the oven, and the overall composition of gases in the oven is controlled as desired. For all the above devices, it is greatly preferred that the incoming gas mixture be pre-conditioned to the test temperature before entering the enclosure or oven where the test plate and samples reside, to avoid cooling the test plate and support plate.

A parallel heat treatment device where heating of the chamber, test plate, and samples is by a combination of convective and radiant heating is set out in another embodiment. Convective heating (involving heat transfer from heated gas to a solid object) and radiant heating are also means by which heat can be transferred uniformly into the test plate, sample pans, and samples. Thus, one embodiment is a test chamber with uniform radiant heating from its walls and with heated gas flow to further assist in heating the test plate as well as contribute to the uniformity of the temperature in the test chamber. The walls of the chamber can be directly heated by means of electrical heaters or recirculating fluid, where these walls then radiate heat into the chamber. However, these ways of heating the walls can result in less than ideal temperature uniformity of the walls and thus in the temperature uniformity obtained in the chamber by radiant heating. Although convective gas flow in the chamber can greatly ameliorate this non-uniformity, in a preferred embodiment, the heating chamber comprises an inner and outer chamber with heated gas flowing between the walls of the inner and outer chambers, as well as within the inner chamber. In this preferred embodiment, only the walls of the outer chamber are directly heated and the inner walls are thus heated indirectly by means of heat radiated from the outer chamber walls as well as by the heated gas flowing through the device. Such a design results in excellent uniformity of temperature within the inner test chamber where the test plate and samples reside.

In further preferred embodiments, preheating of the gas is accomplished by passing it through a tortuous or labyrinthine path in the heated walls of the outer chamber. Such a labyrinth plate can also be designed to provide uniformly distributed flow of the heated gas as it passes through the test chamber.

Further useful components of the above parallel heat treatment devices may include at least one thermocouple mounted just below the test plate to monitor the sample temperature, and a tunable controller receiving feedback from the thermocouples to maintain the temperature of the heating chamber.

In a preferred embodiment, the sample pans are commercially available differential scanning calorimetry (DSC) or thermogravimetric analysis (TGA) pans.

The test plate can be made from a variety of high melting metals or alloys that have good thermal conductivity such as steel, brass or others. Alternatively, the test plate is made from an inorganic material such as quartz or a ceramic. Preferably the test plate is made from a material that is inert to oxidation or other chemical or physical changes that can introduce a surface layer with reduced thermal conductivity. For heat treatments involving lower temperatures, the test plate is preferably made of a heat resistant plastic compound in an embodiment of the invention. The test plate is sized and shaped to receive at least one sample pan, and preferably a rectangular or circular plate machined to accommodate a plurality of sample pans. In one such embodiment, the plate is machined with seats to accommodate a multiple number of sample pans and in a preferred embodiment forty-eight or more DSC pans in a two-dimensional grid pattern. Each of the forty-eight seats of the plate, with each seat being adapted to hold one sample pan, is surrounded by depressions to facilitate the placing of individual pans on the test plate and the removal of individual pans from the test plate. In a preferred configuration, three depressions are arranged equilaterally around each seat to accommodate the three fingers of a robotic gripper in the handling of the sample pans on automated devices used for introducing samples into the pans or for weighing the pans.

Also disclosed herein are methods of parallel thermogravimetric analysis. In these methods, two or more samples are tested simultaneously, preferably twenty-four or more samples, and most preferably forty-eight or more samples. In some of these methods, the multiple samples are all different materials. Alternatively, the multiple samples will include replicates for improved statistical reliability; or the multiple samples will include standards for control charting purposes. Preferably, all samples should be approximately the same weight for improved reproducibility and intercomparability among samples.

These methods may include the following steps: (a) providing a number of empty sample pans corresponding to a number of samples; (b) weighing the tare weight of each of the empty sample pans; (c) adding a sample to each of the sample pans; (d) weighing the gross weight of each of the samples plus its sample pan prior to any thermal and/or other treatments; (e) subjecting the samples to the same thermal and/or other treatment; and (f) measuring the gross weight of each of the samples plus its sample pan after the thermal and/or other treatment.

Embodiments of these methods include one or more thermal treatment steps. Thermal treatment includes isothermal or non-isothermal. Further, embodiments of the invention include thermal treatment steps incorporating other treatment factors in addition to just temperature; for example, exposure to a controlled humidity environment, vacuum, pressure, reactive gas, solvent vapor, ionizing radiation, ultraviolet light, visible light, and so on. These methods include treatment steps other than thermal treatment, such as the factors just mentioned in alternate embodiments of the invention. These methods include any number of post-treatment weighings in alternate embodiments of the invention. This includes a series of weighings made as a function of time during some more extensive treatment; for example, daily weighings of samples being exposed to a hot and humid environment. A long treatment is considered as consisting of a number of sequential shorter treatments.

The goal of all such methods is to determine weight loss or gain of samples that have been simultaneously subjected to one or more thermal and other treatments. For any particular method, there will be a number i=1, 2, . . . N of post-treatment weighings for each sample where the total number of weighings N is at least 1. For each sample, the net weight loss or gain after the i-th treatment step relative to the original sample weight, expressed as a percentage, is given by:

Percent (%) weight change=100%×[{[W(4i)−W(1)]/[W(2)−W(1)]}−1]

where W(1) is the sample pan tare weight, W(2) is the gross weight of sample plus pan prior to any treatment, and W(4i) is the gross weight of sample plus pan after the i-th treatment step.

Isothermal treatment involves a simultaneous exposure of all the samples to a temperature ranging from −120° C. to 700° C. for a period of time ranging from 1 minute to 20,000 hours. Isothermal treatments by necessity will typically include transients at the start and end where the sample temperature goes between ambient temperature and test temperature. The preferred temperature and time can vary widely depending on the goal of the test procedure and thus the entire range of temperatures and times can have utility and be preferred for certain thermogravimetric type analyses. For example, a short period of time (5 minutes) at high temperature (700° C.) for ashing tests to determine filler level; or a moderate period of time (60 minutes) at modest temperature (177° C.) to assess the removal of high boiling solvents from coatings; or a long period of time (20,000 hours) at modest temperature (80° C.) to assess weight loss of plasticizer from plastics compounds during heat aging. Non-isothermal treatment involves a simultaneous exposure of all the samples to some sequence of “ramp” (changing temperature) and “soak” (hold at fixed temperature) steps. During ramp steps the temperature can change linearly with time, or non-linearly (e.g., exponentially). Temperature range for non-isothermal treatments is from −120° C. to 700° C. Soak times can range from 1 minute to 20,000 hour. Similarly, as for isothermal tests, the preferred non-isothermal treatment profile will vary widely depending on the purpose of the analysis. Heating and cooling rates during non-isothermal treatments, and during start and end transients for isothermal treatments, can be up to 200° C. per minute. Design of the apparatus including the sample holder tray will have a significant effect on how rapidly samples can be heated or cooled during thermal treatments. As mentioned previously, thermal treatment steps optionally include other factors; for example, exposure to a controlled humidity environment, vacuum, pressure, reactive gas, solvent vapor, ionizing radiation, ultraviolet light, visible light, and so on.

During the heating, a carrier gas, such as nitrogen or atmospheric air, is introduced to the heating chamber in some embodiments of the invention. Preferably, the carrier gas is brought to substantially the temperature of the heating chamber. In one embodiment, this is performed, at least in part, by introducing the carrier gas through a labyrinth plate in thermal contact with other portions of the heating chamber.

Where the thermogravimetric analysis being conducted is used to screen the heat resistance of epoxy compounds for electrical laminate applications, the carrier gas is preferably nitrogen, devoid of oxygen, because a nitrogen carrier gas mimics the conditions within a cured epoxy laminate. A similar preference for nitrogen carrier gas exists generally when the thermal degradation process of interest occurs under conditions that are essentially air-free, for example in the interior of a thick plastic part. To enable the separation of purely thermal degradation processes from oxidative degradation processes, it is often preferable to run two sets of analyses, the first analysis with inert carrier gas such as nitrogen and the second analysis with air as the carrier gas.

In addition to the parallel heat treatment device, the other component of a pTGA equipment system is a device for robotic weighing of samples at various stages in the overall analysis. Essential components of the robotic weighing device are: (1) a balance; (2) a holder for the test plate holding the samples; (3) a robotic arm with an end effector for gripping, manipulating and moving sample pans; and (4) a computer for controlling the device and for data acquisition. Because pTGA methods involve a large number of weighings, each sample pan is preferably assigned an identifying code and weights and other data are preferably entered automatically into a database.

In a preferred embodiment, the sample pans are moved between the scale and the test plate by a robotic gripper. Preferably, the gripper operates smoothly with minimal force applied to the pans to avoid dislodging samples. The weighing of each sample pan is preferably performed by a five-place analytical balance. Multiple arms and/or multiple balances on the robotic weighing device will increase the sample throughput.

The pTGA equipment system and methods described herein are particularly useful for screening the heat degradation properties of plastics, for example, epoxy compounds for electrical laminates. Such equipment and methods may also be used in screening potential flame retardant and/or ignition resistant materials. As would be obvious to a skilled practitioner, such equipment and methods will also be useful for a variety of other materials analysis problems. As further examples, not to be taken as limiting, such pTGA equipment systems and methods are useful in determining the percentage of non-volatile material in a sample; determining the filler content of polymer compounds via ashing; determining moisture content in materials and at what temperature it is lost; determining weight loss or gain after reaction with a particular carrier gas or with a chemical reagent in an inert carrier gas; determining the level of residual solvent in a coating after undergoing a particular drying and curing process; determining weight gain of materials in a humid environment; and so on.

Further to the description provided above, the following sets forth further details of particular selected embodiments of a pTGA equipment system and methods.

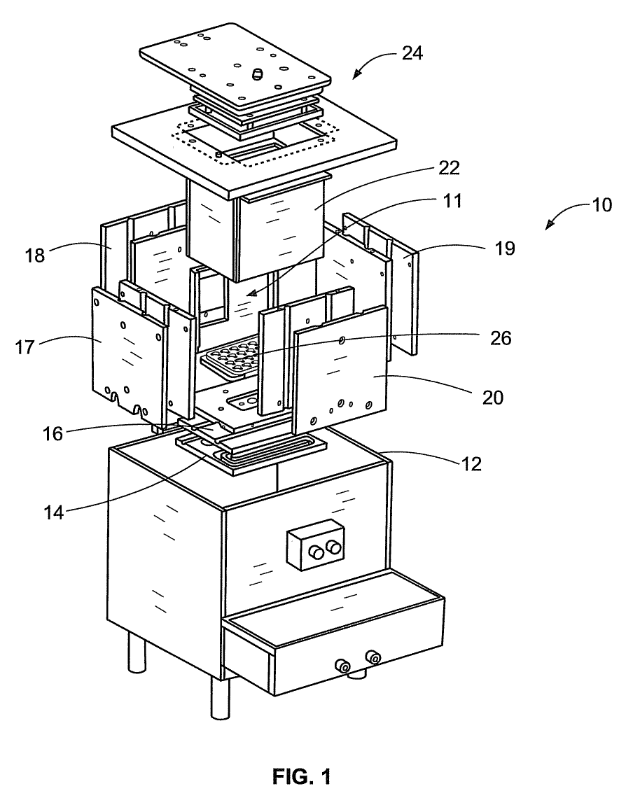

FIG. 1 is an exploded perspective view of a heating chamber for parallel heat treatment. A heating chamber 10 includes an outer housing 12. Assembled within the outer housing 12 are a support or labyrinth plate 14 beneath a bottom heating plate 16, and side heating plate assemblies 17, 18, 19, and 20. The heating plate assemblies surround inner heating chamber walls 22. Cover assembly 24 is provided to insulate the heating chamber 10 when closed and to permit insertion and removal of a test plate 26 when open.

In one specific embodiment, as illustrated in FIG. 1, the heating chamber 10 is provided with a nested design. An inner chamber 11 is provided for accommodating the test plate 26, together with its sample pans (not illustrated). The inner chamber 11 is approximately 15 cm wide, 12.5 cm long and 20 cm deep. An air gap of approximately 0.5 cm surrounds the inner chamber 11. Heating plate assemblies 17, 18, 19, and 20, that are constructed of a heat-conductive material, such as a metal, surround the air gap. Cartridge heaters (not illustrated) are embedded within these heating plate assemblies. The heating plate assemblies 17, 18, 19, and 20 tend to even out undesirable temperature gradients that may otherwise be caused by the cartridge heaters. The air gap between the heating plate assemblies 17, 18, 19, and 20, and the inner chamber 11 enables radiant heat transfer from the heating plate assemblies to the inner chamber, further contributing to the elimination of undesirable temperature gradients in the inner chamber and thus the test plate 26.

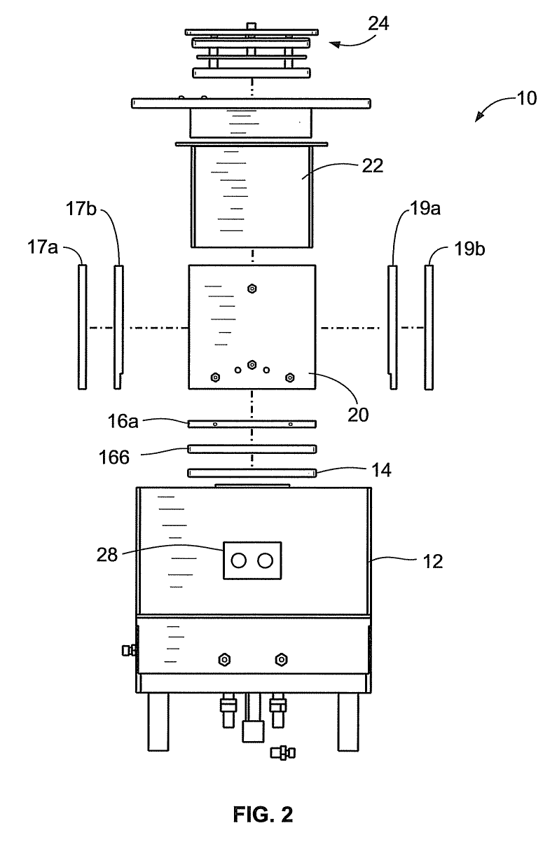

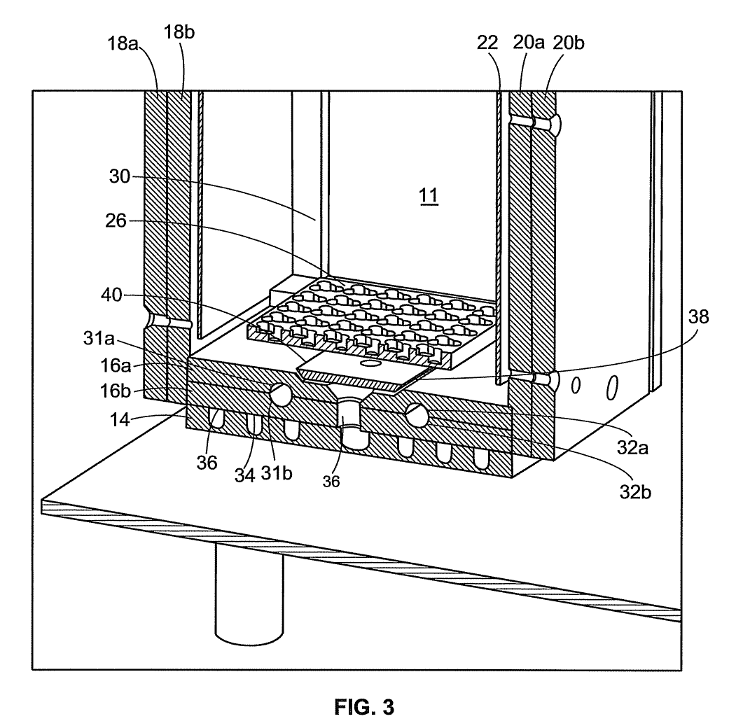

FIG. 2 is an exploded front view of the heating chamber 10 of FIG. 1. As is more clearly visible in FIG. 2, each heating plate assembly is preferably assembled of two heating plates. For example, heating plates 16a and 16b comprise heating plate assembly 16, heating plates 17a and 17b comprise heating plate assembly 17, and heating plates 19a and 19b comprise heating plate assembly 19. (Heating plates 20a and 20b that comprise heating plate assembly 20, and heating plates 18a and 18b that comprise heating plate assembly 18 are visible in FIG. 3). Cartridge heaters (not illustrated) are preferably disposed between the two heating plates of each heating plate assembly when the heating chamber is assembled for operation. As is further illustrated in FIG. 2, controls 28 are provided.

In a preferred embodiment, as shown in these figures, the heating plate assemblies form a box shape when assembled, with at least a horizontally oriented bottom heating plate 16 and four vertically oriented side heating plate assemblies 17, 18, 19, and 20, and ten cartridge heaters (not illustrated) of power 150 W or greater are embedded in the heating plate assemblies, with two such heaters in each of the four side plates and in the bottom plate. The cartridge heaters are more or less pencil shaped, approximately 15 cm long and 0.94 cm diameter. A removable top plate is also provided to allow vertical insertion and removal of the test plate 26 and/or sample pans from the heating chamber 10.

FIG. 3 is a cutaway perspective view of a heating chamber for parallel heat treatment, including a cutaway view of a test plate 26 positioned horizontally in the heating chamber. The test plate 26 is mounted on a lift mechanism 30 to permit insertion and removal of the test plate via the cover assembly 24 (see FIG. 1). The heating plates 16a and 16b each have half-cylindrical recesses 31a, 32a and 31b, 32b. In the assembled heating chamber, the half-cylindrical recesses mate to form cylindrical holes or receptacles in which the cartridge heaters (not illustrated) are disposed. Each heating plate assembly is preferably assembled in a similar fashion.

In the device embodiment described here, the test plate 26 as a whole is shuttled into and out of the heated chamber with a vertical lift system 30, which may be pneumatic. This provides enhanced safety and greater reproducibility of timing associated with inserting and removing the test plate 26 into and from the inner chamber 11.

The labyrinth plate 14 is provided with a meandering recess 33 that defines a passageway for the introduction of carrier gas into the heating chamber 10. At least one wall of the passageway is preferably formed by a surface 34 of a heating plate assembly, such that the carrier gas directly contacts the heating plate assembly as it is transported into the heating chamber and thereby more effectively equilibrates to the temperature of the heating chamber. After traveling through the recess 33, the carrier gas flows through a passage 36 and is diffused through an outlet 38 defined by a diffuser 40 into the inner heating chamber 11.

In a preferred embodiment, as shown in these figures, the heating chamber 10 is provided with a labyrinth plate 14. The labyrinth plate 14 provides a high surface area, torturous path 33 for the flow of carrier gas into the heating chamber 10. The labyrinth plate 14 is preferably in direct physical and thermal contact with at least one of the heating plate assemblies. As a result, carrier gas introduced to the inner chamber 11 through the labyrinth plate 14 has time to reach a substantial thermal equilibrium with the heating chamber.

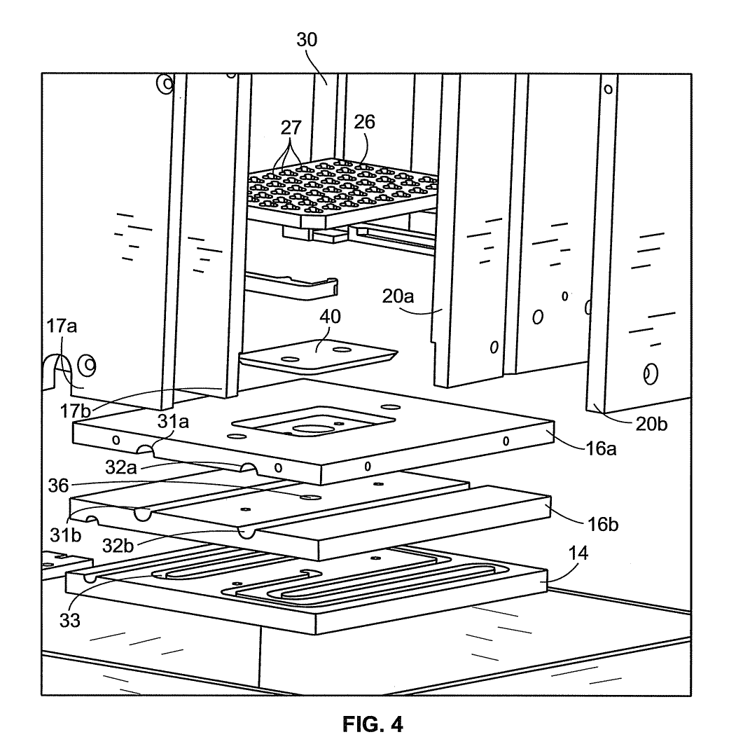

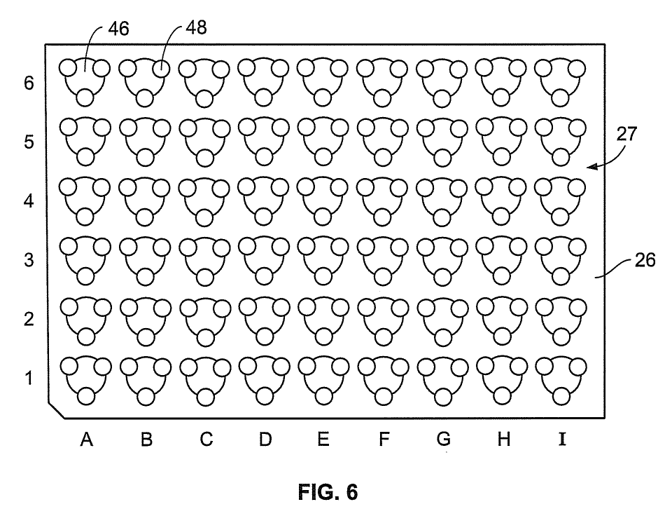

FIG. 4 is an exploded perspective view of a heating chamber for parallel heat treatment, including the elements described above. Particularly visible in FIG. 4 is the rectangular array of seats 27 machined into the test plate 26. Each seat 27 is surrounded by three recesses (not separately designated, see FIG. 6) in a substantially equilateral arrangement to permit insertion and removal of sample pans by a three-fingered robotic gripper (not illustrated).

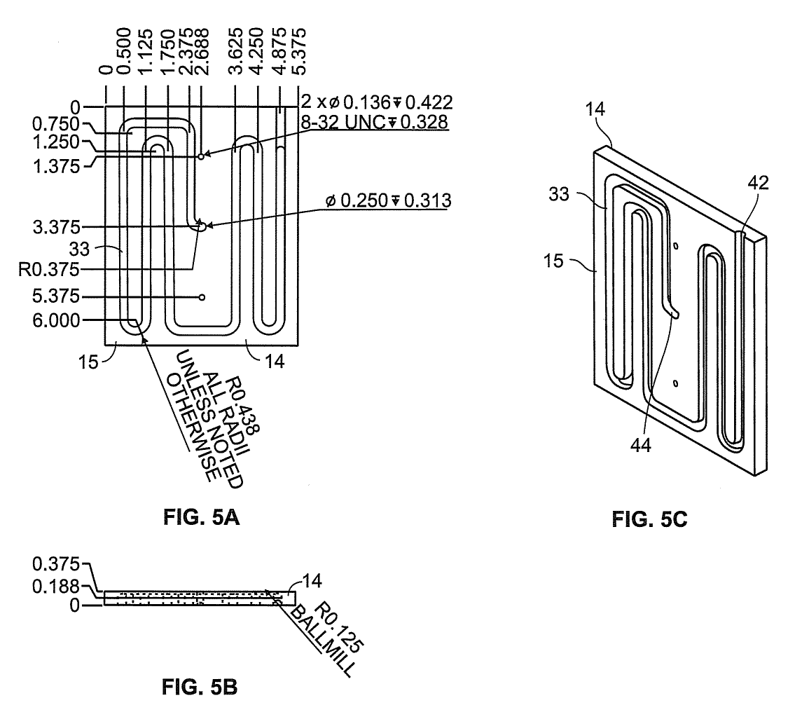

FIGS. 5a-c illustrate the labyrinth plate 14. FIG. 5a is a top view (relative to the position of the labyrinth plate as installed in the heating chamber, FIG. 5b is a front view, and FIG. 5c is a perspective view. FIGS. 5a-5c show with precision a preferred arrangement of the meandering recess 33, through which carrier gas flows in a sense from an inlet portion 42 to an outlet portion 44.

In one embodiment, the labyrinth plate 14 provides a path of approximately 100 cm for the flow of carrier gas. The flow of carrier gas, such as a flow of nitrogen at approximately 95 liters per minute, can be used in maintaining even heating across the test plate 26 (see FIG. 1). The labyrinth plate 14, in a preferred embodiment, is a metal plate having a surface 15 into which a labyrinthine recess or groove 33 is formed. In such an instance, the surface 15 into which the labyrinthine groove 33 is recessed is disposed in physical contact with at least one of the heating plate assemblies. In this way, the carrier gas directly contacts that heating plate assembly as it makes its way toward the inner chamber 11.

In alternative embodiments, the labyrinth plate 14 takes other forms, for example, using different paths for the recess 33, using multiple paths, using paths that branch and/or rejoin along the way, or by using baffles or other high-surface area configurations for equilibrating the gas temperature.

FIG. 6 illustrates a test plate 26 into which fifty-four seats 46 have been machined in a nine-by-six rectangular grid arrayed horizontally. Each seat is surrounded by depressions 48 to accommodate the fingers of a robotic gripper.

In one specific embodiment, as illustrated in FIG. 6, the test plate 26 is rectangular in shape and is sized to 12.7 cm×8.5 cm. The seats 46 are preferably machined to such a depth that tops of sample pans (not illustrated) disposed therein are substantially flush with the top surface 27 of the test plate 26. Preferably, the seats 46 for the sample pans provide a secure fit to minimize jostling of samples disposed in the sample pans during handling of the test plate 26 which can potentially result in loss of material from the pans.

As an optional feature, a test plate cover is provided to facilitate transport of the test plate 26 without disruption of its contents. The test plate cover may be constructed of a TEFLON™ sheet machined to size and releasably held to the top surface of the test plate with knurled machine screws, for example. In a preferred embodiment, these machine screws provide anchor points for inserting and retrieving the test plate into and out of the heating chamber.

At least one thermocouple, and preferably a plurality of them, is disposed in the heating chamber. One preferred location for a thermocouple is immediately below the position of the test plate. The thermocouples may be J-type thermocouples. One or more thermocouples may be used to provide feedback for a tunable PID-type controller that controls the power to the various heaters and thereby maintains the heating chamber at precise temperatures. As examples of suitable temperature controllers, an Omron E5CK PID controller may be used to control temperature and an Omron E5CN on/off controller may be used to monitor and provide a high-temperature cutoff. Such a controller, when used with a type J thermocouple, provides an accuracy of 0.3% of the indicated temperature value, or of 1° C., whichever is greater. A typical operating temperature of the heating chamber when used to measure the thermal degradation of plastics is 300° C.

Inasmuch as the parallel heat treatment apparatus as described herein was used as a platform to test the viability of parallel thermogravimetry generally and of the design of the heating chamber in particular, it proved advantageous to use a plurality of thermocouples to measure temperature in multiple locations within the chamber to assess temperature uniformity, temperature gradients, and the time needed for the apparatus to reach thermal equilibrium. It is to be understood that in a commercial embodiment, particularly once the properties of the apparatus are well known, fewer thermocouples may be deemed necessary.

As described herein, the pTGA equipment system may comprise a parallel heat treatment apparatus such as described above and a robotic weighing apparatus. One embodiment of a suitable robotic weighing apparatus is a Cartesian (x-y-z) robot equipped with a balance and effectors on the robotic arms for gripping and manipulating samples. As a specific embodiment of such a robotic weighing apparatus, a TECAN™ Evo robot is provided with a plate storage area capable of holding four test plates. The robot has an x-y-z overhead arm equipped with a pneumatic gripper. The robot is programmed to use the pneumatic gripper to transport each sample pan to the analytical balance, to record the weight of the sample pan, and to return each sample pan to the test plate in turn. The weighing of each pan takes approximately one minute, and the weighing of all samples in a 54-pan test plate takes approximately one hour.

The heating of multiple samples simultaneously in a single thermogravimetric heating chamber poses the critical technical challenge of keeping the temperature even across the test plate. Without substantial temperature uniformity across a test plate, the utility of a parallel heat treatment apparatus would be limited. Therefore, experiments were performed to verify temperature uniformity for the parallel heating chamber whose design is described above. The examples below also demonstrate that the precision of percent weight loss as determined with the pTGA equipment system and method is comparable to the precision obtained with existing serial-type TGA instruments. Lastly, the examples below clearly show the benefits of the pTGA equipment system and methods in markedly reducing the analysis cycle time per sample.

### Example 1

The pTGA equipment system described above was used to measure the thermal degradation of an epoxy resin formulation, which is typically used for making electrical laminates. A fully cured film of an epoxy resin formulation that was to be used as the sample material for the pTGA experiment was prepared by a two-step process. In the first step, the epoxy resin varnish was partially cured to just short of gelation on a stroke cure plate then quickly spread into a thin film on a glass plate. In the second step, the epoxy-coated glass plate was further cured in an oven for 1.5 hour at 190° C. After cooling, the cured epoxy resin film was removed from the glass plate. The film had <1 weight % of residual solvent as measured by conventional thermogravimetric analysis and had a glass transition temperature as measured by differential scanning calorimetry (DSC) of about 170° C. This film is designated as sample E1.

The first step of the pTGA experiment involved weighing six empty aluminum DSC pans, distributed among the recesses in a 54-well test plate, with a robotic weigher. The second step involved adding small pieces, typically <10 mg, cut from the film sample E1 to the pans, then weighing the sample-containing pans with the robotic weigher. The third step of the pTGA experiment involved transferring the test plate into the above-described parallel heat treatment apparatus, which had been pre-heated to 300.5° C. and thermally degrading samples at that temperature for 35 minutes. During this heat treatment there was a flow of nitrogen through the chamber of about 95 L/minute. The test plate was then removed from the chamber and cooled. The fourth step of the pTGA experiment involved weighing the pans containing degraded samples with the robotic weigher. The percent weight loss was calculated from the weights obtained at steps 1, 2, and 4 by the equation given in the general description of the invention.

The mean percent of sample weight remaining after heating was 57.9%, with a standard deviation of 4.2. The large standard deviation was mostly due to a single sample that appeared to be an outlier. If the sample with the highest standard deviation was removed, the mean was 56.2% and the standard deviation was 0.8. This standard deviation is comparable to the standard deviation of baseline tests conducted using standard serial TGA on film sample E1. The reason why one sample was an outlier in this pTGA experiment is unknown. Potential reasons why one sample showed less weight loss would be non-uniform temperature across the test plate or material non-uniformity in the film sample E1 from which samples were cut. Examples 2 and 3 below show that the temperature uniformity across the test plate appears to be good, suggesting that the outlier weight loss result in this experiment was due to material heterogeneity in the film.

For this pTGA experiment, the total time associated with weighings (1 minute per weighing of a single sample, thus 18 minutes for weighing the six samples three times each) and the thermal treatment (35 minutes for all six samples simultaneously) is approximately 53 minutes. This corresponds to a cycle time per sample of approximately 9 minutes for this pTGA experiment. The same thermal treatment on a single sample using existing commercial serial-type TGA instruments would have a cycle time of approximately 38 minutes. Even running just six samples using the pTGA equipment system and method results in 75% reduction in cycle time per sample and four-fold increase in sample throughput. This clearly demonstrates the substantial benefits in terms of reduced cycle time per sample and correspondingly higher sample throughput rate for the pTGA equipment and methods compared to existing one-at-a-time TGA equipment.

Additional benefits follow from the reduced cycle time per sample. For example, a greater number of replicates per material can be run in a given amount of time resulting in more statistically reliable determination of weight loss. Furthermore, it should be apparent that using a robotic weigher reduces operator time involved in weighing samples, and that operator time involved in introducing and removing samples for thermal treatment is reduced by doing these operations for multiple samples at a time.

### Example 2

An experiment was conducted to test whether the position of a sample on the test plate affects the outcome of thermal degradation. A substantially uniform temperature across the test plate will result in small differences between weight loss results for samples in different locations.

Films of two epoxy resin formulations with slightly higher glass transition temperatures and better thermal resistance properties than the epoxy formulation of Example 1 were prepared using methods essentially the same as those described in Example 1. These films are designated as samples E2 and E3.

The same pTGA equipment system and method as used in example 1 was applied to three samples each of film samples E2 and E3. With reference to the alphanumeric designations of rows and columns in the test plate 26 of FIG. 6, the three sample pans of film E2 were located at positions A1, C4, and H6. Position C4 is near the center of the test plate, while the two other positions are at or near the opposite corners of the plate. The three sample pans of film E3 were located at positions E4 (near center) and H1 and A6 (opposite corners). Tables 1 and 2 show that there were only small differences in percent weight remaining among the locations, with the possible exception of position H1. These results imply good uniformity of temperature across the test plate, which is a critical requirement for the above-described parallel heat treatment device to be of greatest utility for such experiments. By comparison with these pTGA experiment results, traditional TGA analysis gave 98% weight remaining for film E2 and 96% for film E3. It can be seen that the pTGA equipment system and methods give the same thermal degradation ranking of films E2 and E3 as conventional TGA equipment. The difference in absolute weight loss is most likely due to differences in transients at the start and stop of the experiments.

TABLE 1
Positional Dependence of Weight Loss for Film Sample E2

| | % Weight |
|---|---|
| Position | Remaining |
| A1 (corner) | 96.6 |
| C4 (near center) | 96.6 |
| H6 (near corner) | 96.2 |
| Mean: | 96.4 |
| Standard Deviation: | 0.2 |

TABLE 2
Positional Dependence of Weight Loss for Film Sample E3

| | % Weight |
|---|---|
| Position | Remaining |
| H1 (near corner) | 94.7 |
| E4 (near center) | 92.1 |
| A6 (corner) | 91.8 |
| Mean: | 92.9 |
| Standard Deviation: | 1.6 |

### Example 3

A more extensive experiment involving 15 samples was performed to examine weight loss variability across the test plate as an indicator of temperature uniformity across the test plate. This experiment used the same epoxy resin formulation as example 1, with the varnish freshly prepared on the day of the experiment. However, in this experiment the cured epoxy specimens for the thermal degradation experiment were prepared directly in the pans as opposed to the free film preparation of example 1. The same pTGA experimental procedure as for examples 1 and 2 was used for this experiment, with the only difference being that the cured sample containing pans of step 2 were made by introducing the epoxy resin varnish directly into the pans then curing the resin in the pans by the following time-temperature program: samples were heated in a convection oven using a heating profile from room temperature to 190° C. over the course of 2 hours, and then held isothermally at 190° C. for 1.5 hours. The weights for the second step that is, weights of pan plus cured sample before heat treatment—were obtained using the robotic weigher after cooling the cured samples to room temperature. These in-situ prepared epoxy samples are designated as sample E1A. Typical net sample weights after curing were 25-30 mg, higher than the free film sample weights of examples 1 and 2.

Table 3 shows results of this experiment. The average weight percent remaining for the 15 samples of cured resin E1A was 56.3% with a standard deviation of 0.2%. These results confirm very good reproducibility of weight loss results across a single test plate. Correspondingly, these results imply very good temperature uniformity across the test plate.

TABLE 3
Positional Dependence of Weight Loss for
In-Situ Prepared Epoxy Sample E1A

| | % Weight |
|---|---|
| Position | Remaining |
| A1 | 56.35 |
| A2 | 56.23 |
| A3 | 56.25 |
| A4 | 56.34 |
| A5 | 56.41 |
| A6 | 56.61 |
| B1 | 56.04 |
| B2 | 56.48 |
| B3 | 56.04 |
| B4 | 56.31 |
| B5 | 56.33 |
| B6 | 56.55 |
| C1 | 56.16 |
| C2 | 56.36 |
| C3 | 56.36 |

For this pTGA experiment, the total time associated with weighings (1 minute per weighing of a single sample, thus 45 minutes for weighing the 15 samples three times each) and the thermal treatment (35 minutes for 15 samples simultaneously) is approximately 80 minutes. This corresponds to a cycle time per sample of approximately 5.3 minutes for this pTGA experiment. The same thermal treatment on a single sample using existing commercial serial-type TGA instruments would have a cycle time of approximately 38 minutes. Even running just 15 samples using the pTGA equipment system and method results in 86% reduction in cycle time per sample and seven-fold increase in sample throughput. This clearly demonstrates the substantial benefits in terms of reduced cycle time per sample and correspondingly higher sample throughput rate for the pTGA equipment and methods.

This example demonstrates the benefits of dramatically reduced cycle time per sample for the overall equipment system and method. It also demonstrates very low variability of weight loss measurements at different locations in the test plate. This demonstrates in turn that the parallel heat treatment device as described above, which exemplifies a number of embodiments of this invention, has very good temperature uniformity across the test plate as is required for such a device to have good utility for a wide range of types of thermogravimetric analyses, examples of which were given in the general description of this invention.

What is claimed is:

1. A parallel heat treatment device, comprising:
an inner heating chamber including a plurality of inner heating chamber walls;
a plurality of heating plate assemblies, each of the plurality of heating plate assemblies disposed outside of and spaced-apart from a respective one of the plurality of inner heating chamber walls;
a bottom heating plate assembly positioned within a bottom portion of the inner heating chamber;
at least one heating element disposed in heating operative communication with each of the plurality of heating plate assemblies and the bottom heating plate assembly;
a test plate positionable within the inner heating chamber on the bottom heating plate assembly, the test plate being sized and shaped to receive a plurality of sample pans; and
a temperature-controlled support plate positioned underneath the bottom heating plate assembly.

2. The parallel heat treatment device of claim 1, wherein there are four inner heating chamber walls.

3. The parallel heat treatment device of claim 1, wherein the inner heating chamber walls are vertically oriented.

4. The parallel heat treatment device of claim 1, wherein each of the plurality of heating plate assemblies includes a pair of heating plates.

5. The parallel heat treatment device of claim 1, wherein each of the pair of heating plates are in direct physical contact with each other.

6. The parallel heat treatment device of claim 4, wherein each of the pair of heating plates includes a half-cylindrical recess formed in facing sides of respective pairs of heating plates and together defining a heating element receptacle when corresponding pairs of heating plates are assembled into the heating plate assemblies.

7. The parallel heat treatment device of claim 1, wherein the at least one heating elements include electrical heaters.

8. The parallel heat treatment device of claim 7, wherein the at least one heating elements include one or more cartridge heater.

9. The parallel heat treatment device of claim 1, wherein the heating plate assemblies and the plurality of inner heating chamber walls are spaced-apart a distance of about 5 millimeters.

10. The parallel heat treatment device of claim 1, wherein the bottom heating plate assembly includes a pair of heating plates.

11. The parallel heat treatment device of claim 10, wherein the bottom heating plate assembly is oriented horizontally.

12. The parallel heat treatment device of claim 10, wherein the pair of heating plates of the bottom heating plate assembly is in direct physical contact.

13. The parallel heat treatment device of claim 10, wherein each of the pair of heating plates includes a half-cylindrical recess formed in facing sides thereof, the half-cylindrical recesses together defining a heating element receptacle when the pair of heating plates are assembled into a bottom heating plate assembly.

14. The parallel heat treatment device of claim 13, including a cartridge heater disposed within the heating element receptacle.

15. The parallel heat treatment device of claim 1, further comprising a source of fluid and wherein the temperature-controlled support plate includes a tortuous path, and wherein the temperature-controlled support plate is heated by circulating fluid from the source of fluid through the tortuous path.

16. The parallel heat treatment device of claim 15, wherein the bottom heating plate assembly includes a passage formed therein that is in fluid communication with the tortuous path formed in the temperature-controlled support plate for conveying a heated gas to the inner heating chamber.

17. The parallel heat treatment device of claim 15, wherein the source of fluid supplies a pre-conditioned gas.

18. The parallel heat treatment device of claim 1, wherein the temperature-controlled support plate has a greater thermal mass than the test plate, sample pans and samples.

19. The parallel heat treatment device of claim 1, wherein outer edges of the temperature-controlled support plate are spaced-apart from outer edges of the test plate.

20. A method of performing parallel thermogravimetric screening of a plurality of samples in sample pans, comprising:
(a) providing a parallel heat treatment device, comprising:
an inner heating chamber including a plurality of inner heating chamber walls;
a plurality of heating plate assemblies, each of the plurality of heating plate assemblies disposed outside of and spaced-apart from a respective one of the plurality of inner heating chamber walls;
a bottom heating plate assembly positioned within a bottom portion of the inner heating chamber;
at least one heating element disposed in heating operative communication with each of the plurality of heating plate assemblies and the bottom heating plate assembly;
a test plate positionable within the inner heating chamber on the bottom heating plate assembly, the test plate being sized and shaped to receive a plurality of sample pans; and
a temperature-controlled support plate positioned underneath the bottom heating plate assembly;
(b) weighing the tare weight of each of the plurality of sample pans in an empty condition;
(c) adding a sample to each of the plurality of sample pans;
(d) weighing the gross weight of each of the samples plus its sample pan prior to any thermal and/or other treatments;
(e) subjecting the samples simultaneously to the same thermal and/or other treatment in the parallel heat treatment device; and
(f) measuring the gross weight of each of the samples plus its sample pan after the thermal and/or other treatment.
